(19) United States
(12) Patent Application Publication
(10) Pub. No.: US 2026/0097515 A1
(43) Pub. Date: Apr. 9, 2026

(54) ROBOT CONTROL BASED ON SKELETON OF WORKPIECE

(71) Applicant: KABUSHIKI KAISHA YASKAWA DENKI, Kitakyushu-shi (JP)

(72) Inventors: Ryo MASUMURA, Fukuoka (JP); Kento YAMADA, Fukuoka (JP); Daisuke KUNICHI, Fukuoka (JP); Marino KASHIYAMA, Fukuoka (JP); Toshiki ITO, Fukuoka (JP); Yukihiro TOBATA, Fukuoka (JP)

(21) Appl. No.: 19/415,781

(22) Filed: Dec. 11, 2025

Related U.S. Application Data
(63) Continuation of application No. PCT/JP2024/018169, filed on May 16, 2024.

(30) Foreign Application Priority Data
Jun. 15, 2023 (JP) 2023-098409

(51) Int. Cl. B25J 9/16; B25J 19/02

(52) U.S. Cl. CPC B25J 9/1697; B25J 9/1661; B25J 9/1664; B25J 19/023

(57) ABSTRACT

A robot system includes circuitry configured to: acquire a workpiece image showing a workpiece present in real space; estimate skeleton information indicating a skeleton of the workpiece based on the workpiece image; acquire constraint information representing a constraint regarding a task to be performed on the workpiece; determine a completion state of the task based on the acquired constraint information and the estimated skeleton information; and cause a robot placed in the real space to perform the task in accordance with the determined completion state.

### CROSS-REFERENCE TO RELATED APPLICATIONS

This application is a continuation application of PCT Application No. PCT/JP2024/018169, filed on May 16, 2024, which claims the benefit of priority from Japanese Patent Application No. 2023-098409, filed on Jun. 15, 2023. The entire contents of the above listed PCT and priority applications are incorporated herein by reference.

### BACKGROUND

### Field

One aspect of the present disclosure relates to a robot system, a robot control method, and a robot control program.

### Description of the Related Art

Conventionally, robots have been developed to handle items such as food and agricultural products. For example, International Publication No. 2021/085345 discloses technology for picking up a plurality of parts heaped in bulk on a rack, using an industrial robot equipped with a parallel gripper as an end effector.

### SUMMARY

A robot system according to one aspect of the present disclosure includes circuitry configured to: acquire a workpiece image showing a workpiece present in real space; estimate skeleton information indicating a skeleton of the workpiece based on the workpiece image; acquire constraint information representing a constraint regarding a task to be performed on the workpiece; determine a completion state of the task based on the acquired constraint information and the estimated skeleton information; and cause a robot placed in the real space to perform the task in accordance with the determined completion state.

### BRIEF DESCRIPTION OF THE DRAWINGS

FIG. 1 is a diagram illustrating an example configuration of a robot system.

FIG. 2A is a diagram illustrating a workpiece and its skeleton information.

FIG. 2B is a diagram illustrating workpieces and its skeleton information.

FIG. 3A is a diagram illustrating an example operation of the robot system.

FIG. 3B is a diagram illustrating an example operation of the robot system.

FIG. 4A is a diagram for explaining a result of an operation of the robot system.

FIG. 4B is a diagram for explaining a result of an operation of the robot system.

FIG. 5 is a diagram illustrating an example hardware configuration of a computer used for the robot system.

FIG. 6 is a diagram illustrating a configuration of a robot system according to a modification.

FIG. 7 is a diagram illustrating an example of keypoints of an estimated workpiece.

FIG. 8 is a diagram illustrating an example process of selecting a workpiece.

FIG. 9 is a diagram illustrating examples of processed workpieces.

FIG. 10 is a diagram illustrating a configuration of a robot system according to a modification.

FIG. 11 is a diagram illustrating an example user interface for generating constraint information.

### DETAILED DESCRIPTION

In the following description, with reference to the drawings, the same reference numbers are assigned to the same components or to similar components having the same function, and overlapping description is omitted.

### Configuration of Robot System

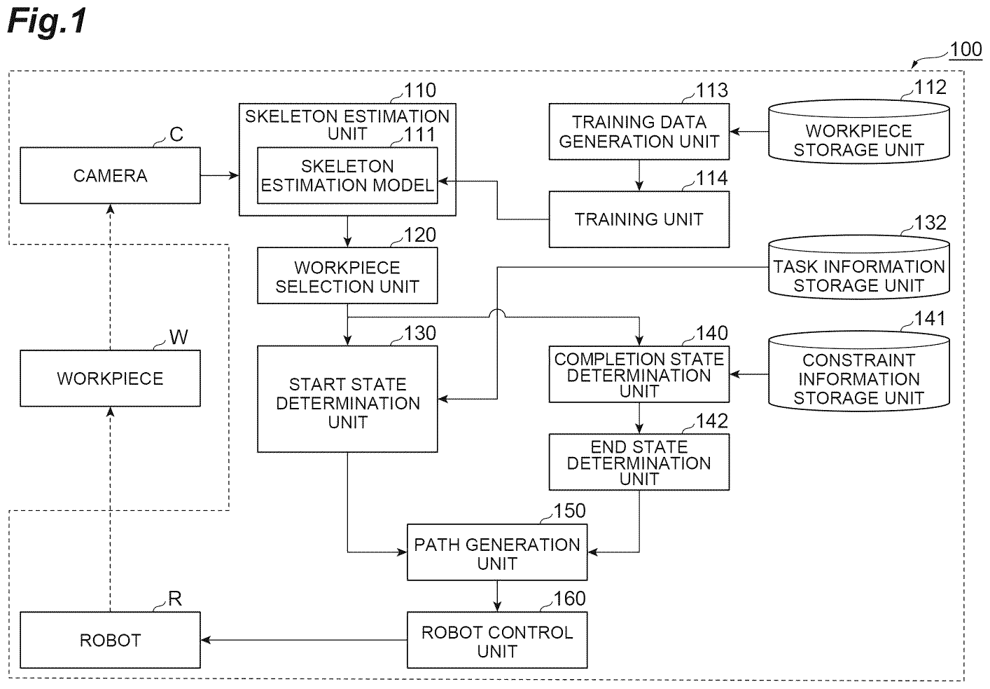

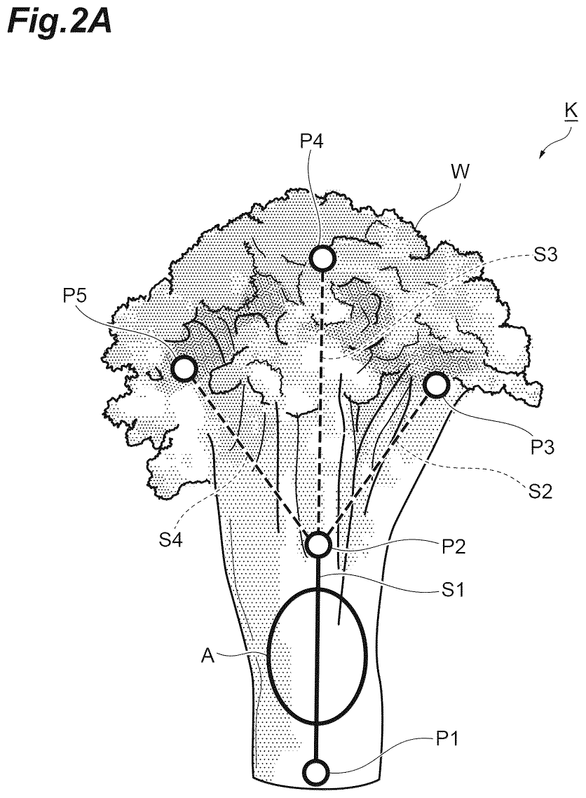

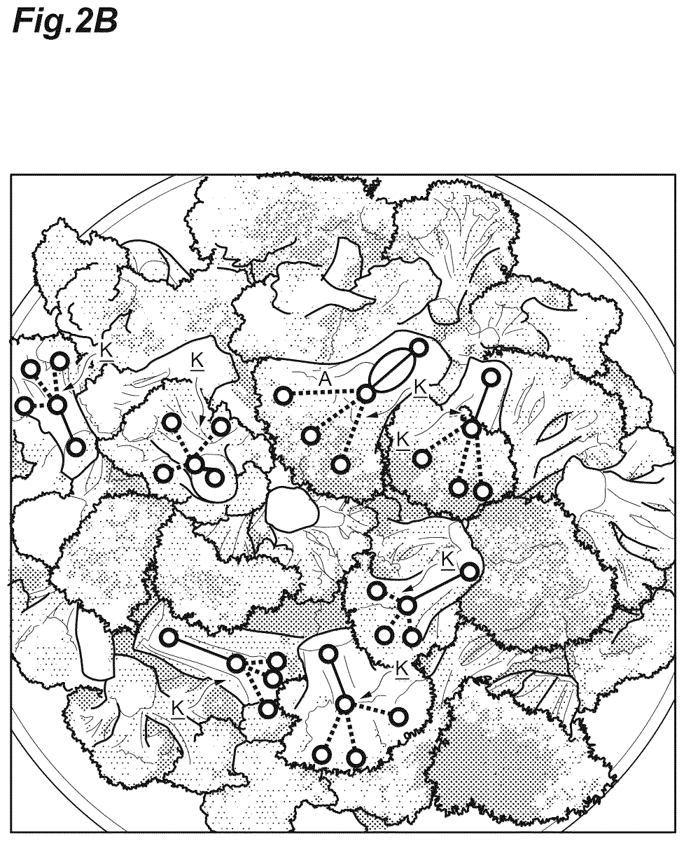

The configuration of a robot system 100 according to an example will be described with reference to FIGS. 1, 2A, and 2B. FIG. 1 is a diagram illustrating an example of the configuration of the robot system 100. Both FIG. 2A and FIG. 2B are diagrams illustrating a workpiece W and skeleton information K of the workpiece W.

The robot system 100 is a control system for causing a robot R placed in real space to process a workpiece W present in the real space. As illustrated in FIG. 1, the robot system 100 includes a camera C, a skeleton estimation unit 110, a workpiece storage unit 112, a training data generation unit 113, a training unit 114, a workpiece selection unit 120, a start state determination unit 130, a task information storage unit 132, a completion state determination unit 140, a constraint information storage unit 141, an end state determination unit 142, a path generation unit 150, a robot control unit 160, and a robot R.

The robot R is a device or an apparatus that performs a task on the workpiece W. The robot R is placed in the real space. The robot R has an end effector that applies a necessary action to the workpiece W in the task. In the following description, it is assumed that the robot R is a vertically articulated robot, but the robot R may be another type of robot such as a horizontally articulated robot or a linear machine.

The task refers to processing performed by the robot R on the workpiece W. The task may be processing that affects the shape of the workpiece W. For example, the task includes at least one of handling of the workpiece W and processing of the workpiece W. Examples of handling include a pick-and-place task, an alignment task, a packing task, an unpacking task, and an assembly task. Examples of processing include a welding task, a painting task, a grinding task, a polishing task, a cutting task, and a printing task. In the following description, it is assumed that the task is a pick-and-place task performed by the robot R on the workpiece W, and cases of other tasks will be supplemented as appropriate.

The robot system 100 may cause the robot R to perform tasks on various workpieces W. For example, the robot system 100 causes the robot R to perform a task on an irregularly shaped workpiece W. The irregularly shaped workpiece W may be a workpiece that is difficult to deform but has individual differences in shape, such as broccoli, fried shrimp, or fried chicken. Alternatively, the irregularly shaped workpiece W may be a workpiece in which individual differences in shape may be ignored but the difference in the degree of deformation between individuals may be large, that is, a flexible object, such as a harness, a cable, or a handkerchief. Alternatively, the irregularly shaped workpiece W may be a workpiece that has the characteristics of these two types of workpieces. As an example of an irregularly shaped workpiece W with individual differences in shape, broccoli is illustrated in FIG. 2A.

The camera C captures an image of the workpiece W and generates a workpiece image, which is an image showing the workpiece W (that is, an image showing the workpiece W). The image may be a two-dimensional image, or may further include a distance image in addition to a two-dimensional image. For example, the camera C is fixed to the tip of an arm of the robot R. The camera C may be fixed to another position of the robot R, or may be fixed to a ceiling or a pillar. A plurality of cameras C may be arranged.

The skeleton estimation unit 110 is a functional module that estimates skeleton information K indicating a skeleton of the workpiece W, based on an image showing the workpiece W. The skeleton information K indicates the skeleton of the workpiece W to an extent that allows planning of a task on the workpiece W by the robot R. The skeleton of the workpiece W represents an outer shape of the workpiece W or a positional relationship of approximate parts of the workpiece W. The workpiece W does not need to have “bones”. For example, broccoli has a structure in which a plurality of stems extend from one stem, and each stem leads to a floret. In a case where the workpiece W is broccoli, the skeleton information K indicates such a positional relationship of approximate parts to an extent that allows the robot R to execute a task on the broccoli.

The skeleton information K of the workpiece W includes a plurality of keys, which is information for indicating the positional relationship of the approximate parts of the workpiece W. The plurality of keys include a plurality of keypoints, which is information indicating the positions of specific parts of the workpiece W, and one or more bones, each of which is a virtual line connecting two keypoints. The bone is also referred to as a beam. In the example of FIG. 2A, the skeleton information K of the workpiece W includes a plurality of keys including a plurality of keypoints P (P1 to P5) and a plurality of bones S (S1 to S4) of the workpiece W. In a case where the workpiece image shows a plurality of workpieces W as in the example of FIG. 2B, the skeleton estimation unit 110 may estimate the skeleton information K for each of the two or more workpieces W.

In some examples, the skeleton estimation unit 110 estimates the skeleton information K of the workpiece W using a skeleton estimation model 111. The skeleton estimation model 111 is an inference engine that receives an input of a workpiece image showing the workpiece W and estimates the skeleton information K of the workpiece W. The estimation of the skeleton information K is performed by the skeleton estimation unit 110 inputting a workpiece image of the workpiece W for which the skeleton information K is to be estimated into the skeleton estimation model 111. The skeleton estimation model 111 may be realized, for example, using a keypoint detection technology represented by OpenPose, RTMPose, YOLOX-Pose, or the like. In the keypoint detection, the position of a specific part is identified from the recognition target of the workpiece W as a keypoint P, and a virtual line (edge) representing the relationship between two positions is inferred as a bone S (beam). These keypoints P and bones S are processed as the skeleton information K.

The skeleton estimation model 111 is generated in advance by machine learning using training data including a plurality of data records in which sample images, which are images based on a three-dimensional model (3D model) of the workpiece W, and a plurality of keys set in the 3D model are associated with each other. Therefore, the skeleton estimation model 111 is a trained model. The plurality of keys in each data record also include a plurality of keypoints and one or more bones each connecting two keypoints. The robot system 100 has a workpiece storage unit 112, a training data generation unit 113, and a training unit 114 as a configuration for performing the training.

The workpiece storage unit 112 is a functional module that stores, as training data, sample images based on a 3D model of at least one workpiece W and skeleton information K of each 3D model. The training data generation unit 113 is a functional module that deforms the 3D model indicated by at least one of the plurality of data records of the training data stored in the workpiece storage unit 112, generates a new data record of the training data, and stores the new data record in the workpiece storage unit 112. In a case where the 3D model is deformed, since the skeleton information K of the original 3D model is known, the skeleton information K (plurality of keys) of the deformed 3D model may be determined. Therefore, a new data record in which the deformed 3D model and the determined skeleton information K are associated with each other may be stored in the workpiece storage unit 112. The training data generation unit 113 may increase the training data by such processing. In the present disclosure, the deformation of the 3D model may include not only processing to change the outer shape of the 3D model to create individual differences in the outer shape of the workpiece W, but also processing to create individual differences in the degree of deformation of the 3D model of a flexible article that is deformable. The training unit 114 is a functional module that trains the skeleton estimation model 111 by machine learning using the training data that may include the new data records, to generate the skeleton estimation model 111. The generation of the skeleton estimation model 111 by the training unit 114 may include updating the skeleton estimation model 111.

The workpiece selection unit 120 is a functional module that selects at least one workpiece W to be processed in a task, based on the skeleton information K estimated for each of a plurality of workpieces W included in the workpiece image. In a case where the workpiece image shows a single workpiece W, the workpiece selection unit 120 selects that workpiece W. As illustrated in FIG. 2B, the workpiece image may include a plurality of workpieces W. In this case, the workpiece selection unit 120 selects at least one workpiece W to be processed in the task from the workpiece image.

For example, the workpiece selection unit 120 selects at least one workpiece based on the skeleton information K of each of the plurality of workpieces W. The workpiece selection unit 120 may select a workpiece W having skeleton information K with a degree of deformation within a predetermined range, such as a workpiece W that extends straight or a workpiece W with a small degree of bending. The workpiece selection unit 120 may select the current workpiece W based on the relationship with previously selected workpieces W such that the variation in the skeleton information K of the workpieces W to be sequentially processed is within a predetermined threshold.

Alternatively, the workpiece selection unit 120 calculates the area on the workpiece image for each of the plurality of workpieces W. Then, the workpiece selection unit 120 selects a workpiece that is entirely exposed in the workpiece image without being covered or buried by other workpieces W or the like, based on the area and the skeleton information K of each of the plurality of workpieces W. The workpiece selection unit 120 may select a workpiece W whose entire skeleton information K is exposed, or a workpiece W in which the ratio of the exposed skeleton information K is equal to or greater than a predetermined threshold, based on the area and the skeleton information K of each of the plurality of workpieces W.

The start state determination unit 130 is a functional module that determines a start state, which is a state of the robot R at the start of a task, based on the skeleton information K of the workpiece W. The start state represents, for example, at least one of a position and a posture of the robot R when starting the task on the workpiece W. The position and posture of the robot R may be the position and posture of the end effector. In a pick-and-place or alignment process, the start state represents, for example, the position and posture of the end effector when picking the workpiece W. In an assembly or processing process, the start state represents, for example, the position and posture of the end effector at the start of the process.

For example, the start state determination unit 130 may analyze the skeleton information K of the workpiece W, convert the skeleton information K into at least one of the position and posture of the end effector when causing the end effector to act on (e.g., picks) the workpiece W, and determine the conversion result as the start state. The start state determination unit 130 may execute the conversion using a function that receives an input of the skeleton information K and calculates the start state, or may extract the start state by geometrically analyzing the skeleton information K. As another example, the start state determination unit 130 may execute the conversion using an inference engine that receives at least an input of the skeleton information K and outputs the start state. Alternatively, the start state determination unit 130 may simulate various start states based on the skeleton information K, evaluate each simulation result with a predetermined evaluation method, and determine the start state that yields the optimal simulation result.

The start state determination unit 130 may determine the start information, based on task information set according to the type of the workpiece W or task on the workpiece W and stored in the task information storage unit 132, and the estimated skeleton information K. In some examples, the task information is defined for each type of workpiece W regardless of individual differences such as the shape of the workpiece W, and is associated with at least one of the plurality of keys of the workpiece W. The task information represents information regarding the task on the workpiece W. For example, the task information includes at least one of the position and posture of the end effector acting on the workpiece W in the start state of the task on the workpiece W.

In the case of a pick-and-place task performed by the robot R on the workpiece W, the task information includes, for each of at least one key of the workpiece W, picking information indicating whether the robot R is able to pick the workpiece W at a position corresponding to the key. The picking information may indicate whether the robot R is able to pick the vicinity of each of the keypoint P and the bone S. The start state determination unit 130 determines a picking position A for the robot R on the workpiece W as the start state, based on the picking information and the estimated skeleton information K. The picking position A refers to a position at which the robot R acts on the workpiece W to pick the workpiece W. For example, in a case where the end effector is a hand, the picking position A represents a gripping position, and in a case where the end effector is a suction pad, the picking position A represents a suction position. In the case of a processing task, the task information may indicate, for each of the plurality of keys (each keypoint P and each bone S) of the workpiece W, whether the processing task may be started in the vicinity of the key.

The completion state determination unit 140 is a functional module that determines a completion state of a task to be performed on the workpiece W, based on constraint information representing a constraint regarding the task on the workpiece W (i.e., a constraint regarding the task to be performed on the workpiece W) and the estimated skeleton information K. The robot system 100 causes the robot R to perform the task in accordance with the determined completion state.

The constraint represents a condition regarding the task on the workpiece W and is stored in advance as constraint information in the constraint information storage unit 141. The completion state determination unit 140 acquires the constraint information from the constraint information storage unit 141. The constraint is defined for each type of workpiece W regardless of individual differences such as the shape of the workpiece W. For example, the constraint includes, for each of a plurality of types of workpieces W, a condition regarding a state constituted by one or more workpieces W after the task is completed. In a case where the task is handling, the constraint may be a condition on the posture (e.g., orientation) of each workpiece W, a condition on an evaluation result in a state where one or more workpieces W are placed or aligned, or a condition on a state constituted by a plurality of workpieces W after assembly is completed. The evaluation result may be calculated by applying a physical measurement values for one or more placed or aligned workpieces W to a predetermined algorithm, or may be calculated by inputting an image showing the one or more placed or aligned workpieces W into a trained model such as a neural network. In a case where the task is a processing task, the constraint may be a condition on the state of one or more workpieces W after the processing task is completed.

The completion state represents an expected state of a specific workpiece W processed by a task to be performed by the robot R in a case where the task is completed. While the constraint is defined for each type of workpiece regardless of individual differences such as the shape of the workpiece W, the completion state is defined in accordance with the shape of the individual workpiece W to be processed by the task to be performed. In a case where the task is handling, the constraint may be a condition of placing the workpiece W with a specific part of the workpiece W facing a specific direction, or a condition regarding an evaluation value of a state where a plurality of workpieces W are placed. Corresponding to such a constraint, the completion state determination unit 140 may determine, as the completion state, a post-placement state, which is a state after the workpiece W is placed, according to the individual shape of the workpiece W (that is, the skeleton information K). The completion state determination unit 140 may determine at least the posture (e.g., orientation) of the placed workpiece W as the post-placement state, and may further determine at least one of the position and shape of the placed workpiece W. For example, the completion state determination unit 140 determines at least the posture of the placed workpiece W and further determines at least one of the position and shape of the placed workpiece W, by defining not only the direction of a specific part of the workpiece W but also the directions of other parts.

The completion state determination unit 140 may convert the constraint information into a value or condition specific to the individual workpiece W to be processed, based on the estimated skeleton information K, and determine the conversion result as the completion state. For example, in a case where the constraint information defines the position and direction of a specific part of the workpiece W, the completion state determination unit 140 identifies a predetermined part of the workpiece W from the estimated skeleton information K, and identifies the position and direction of the individual workpiece W such that the identified part has the position and direction defined by the constraint information. Then, the completion state determination unit 140 determines the state of the workpiece W placed at the identified position and in the identified direction as the completion state. The completion state determination unit 140 may determine the completion state using a function that receives an input of the skeleton information K and calculates the completion state based on the constraint information, or may extract the completion state by geometrically analyzing the skeleton information K based on the constraint information. As another example, the completion state determination unit 140 may determine the completion state using an inference engine that receives at least an input of the constraint information and the skeleton information K and outputs the completion state. Alternatively, the completion state determination unit 140 may simulate various completion states based on the skeleton information K and the constraint information, evaluate each simulation result with a predetermined evaluation method, and determine the completion state that yields the optimal simulation result.

As described above, the robot system 100 causes the robot R to perform the task in accordance with the determined completion state. In some examples, the task in accordance with the completion state is a task of transitioning the state of the workpiece W to the completion state, and in this case, the robot system 100 may achieve the completion state as a result of the task. As another example, in the case of a task where the completion state is determined at the time the robot R starts the task, the robot system 100 may also achieve the completion state by determining the starting state of the task. For example, in a case where the start position of welding on the workpiece W is defined as a constraint, the robot system 100 may determine an individual welding start position for the workpiece W as the completion state based on the constraint in accordance with the individual difference of the workpiece W, and cause the robot R to start the task from the welding start position.

The end state determination unit 142 is a functional module that determines an end state, which is a state of the robot R in the completion state, based on the determined completion state. If the robot R may be operated by the completion state without using the end state, the process of determining the end state may be omitted. In this case, the end state may be read as the completion state as appropriate. Examples where the end state is not necessary include a case where the completion state directly represents the end state, and a case where the operation of the robot R is uniquely determined by the determination of the completion state.

The end state represents, for example, at least one of a position and a posture of the robot R when the task on the workpiece W is completed. The position and posture of the robot R may be the position and posture of the end effector. In a pick-and-place or alignment process, the end state represents, for example, the position and posture of the end effector when placing the workpiece W. In an assembly or processing process, the end state represents, for example, the position and posture of the end effector at the completion of the process.

For example, the end state determination unit 142 may convert the completion state of the workpiece W based on the configuration of the robot R or the end effector, identify the position and the posture of either the tip of the arm of the robot R or the end effector, and determine the identification result as the end state. A case where the completion state of the workpiece W is passed through indirectly rather than explicitly, that is, a case where the completion state determination unit 140 and the end state determination unit 142 are integrated into a series of processes, and the end state is determined as if from the constraint information and the skeleton information K, is also included in the scope of the present disclosure. By configuring the completion state determination unit 140 and the end state determination unit 142 separately, their respective processes do not depend on each other, so a robot system applicable to various workpieces W and various robots R may be more readily constructed.

The path generation unit 150 is a functional module that generates a path of the robot R based on the determined start state and end state. The generation of the path is also called path planning. The path represents, for example, a trajectory of the operation of the robot R from a start point to an end point. The path generation unit 150 may collect information on the surrounding environment such as obstacles in addition to the start state and the end state, and generate a path such that the robot R and a conveyed object do not interfere with the obstacles. In the case of pick-and-place, the conveyed object is the workpiece W. The path generation unit 150 may generate the path by other methods.

At least one of the start state and the end state may include a predetermined operation of the robot R uniquely determined by the state, and the predetermined operation may include an approach point. In this case, the path generation unit 150 may generate a path from the approach point or a path to the approach point.

In a case where the path is unable to be generated, the path generation unit 150 may cause at least one of re-determination of the end state by the end state determination unit 142 and re-determination of the start state by the start state determination unit 130 to be executed, and generate (regenerate) a path based on at least one of the re-determined end state and the re-determined start state. That is, the robot system 100 may re-determine at least one of the end state and the start state in a case where the path is unable to be generated. The path generation unit 150 may plan to re-grasp the workpiece W in the process of generating or regenerating the path for a predetermined task such as pick-and-place. As an example, consider a case where the robot system 100 temporarily places the workpiece W on a placement table, changes the way of holding the workpiece W, and continues the pick-and-place. In this case, the robot system 100 may process each of the task of carrying the workpiece W to the placement table and the task of transitioning the workpiece W placed on the placement table to the completion state as a pick-and-place. The robot system 100 (path generation unit 150) may, in a predetermined situation such as a case where a path from the start state to the end state is unable to be generated, divide the task of directly transitioning the workpiece W to the completion state into a task of placing the workpiece W on the placement table and a task of transitioning the workpiece W placed on the placement table to the completion state, and generate a path for each of the divided tasks.

The robot control unit 160 is a functional module that causes the robot R to perform the task in accordance with the determined completion state. For example, the robot control unit 160 controls the robot R such that the robot R executes a task of transitioning the workpiece W to the completion state with the end effector. The robot control unit 160 may cause the robot R to perform the task in accordance with the completion state, based on at least one of the start state and the end state. For example, the robot control unit 160 causes the robot R to perform the task based on the path generated based on the start state and the end state. The robot control unit 160 may cause the robot R to perform the task based on the path generated (regenerated) based on at least one of the re-determined start state and the re-determined end state. With such robot control, a task according to the skeleton information K of the workpiece W is performed, so that the accuracy or reliability of the task on the workpiece W may be improved, or the types of workpieces W processed by the robot R may be increased.

### Operation of Robot System

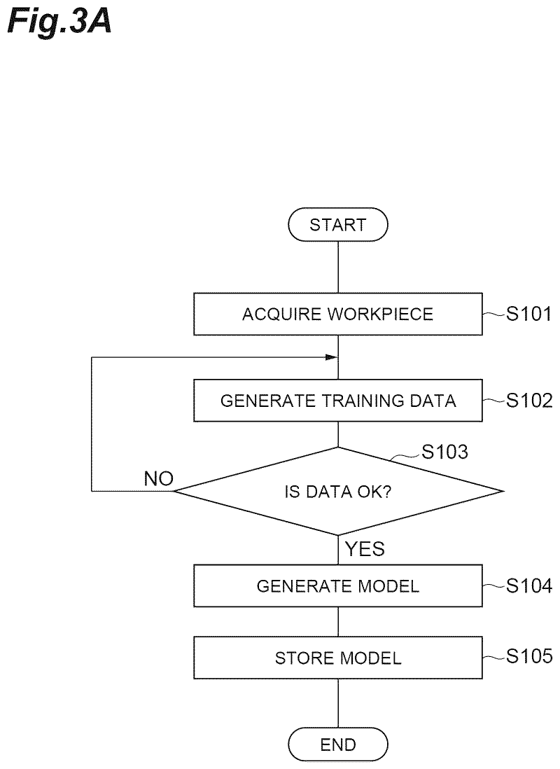

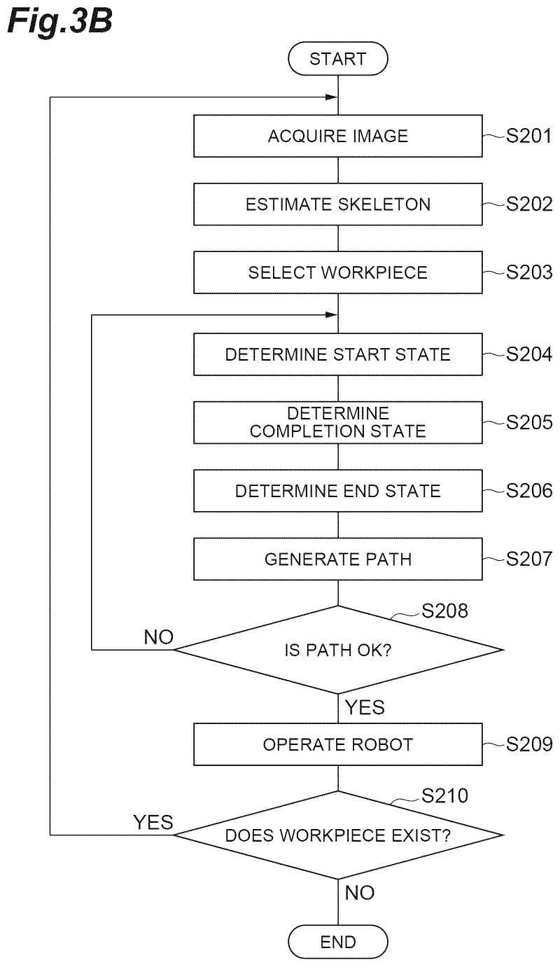

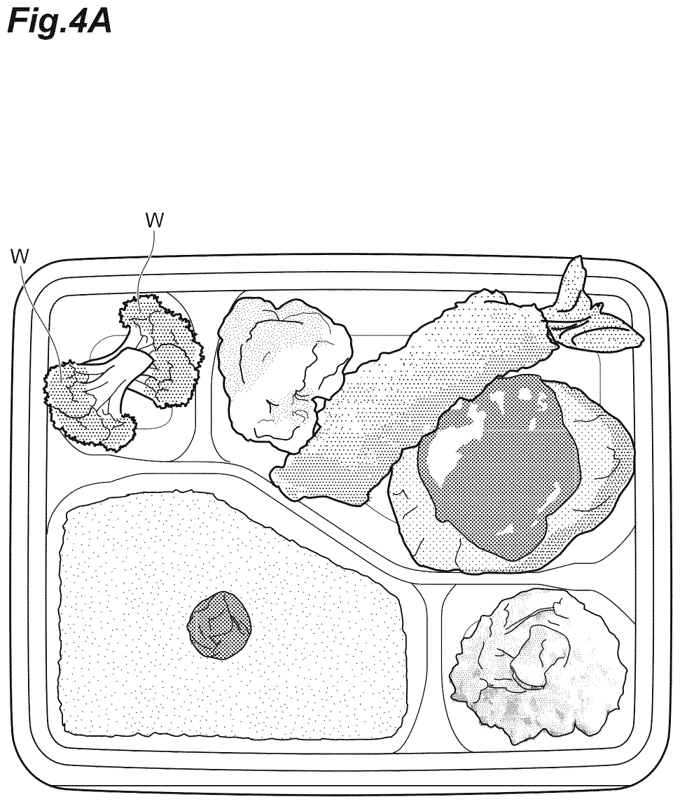

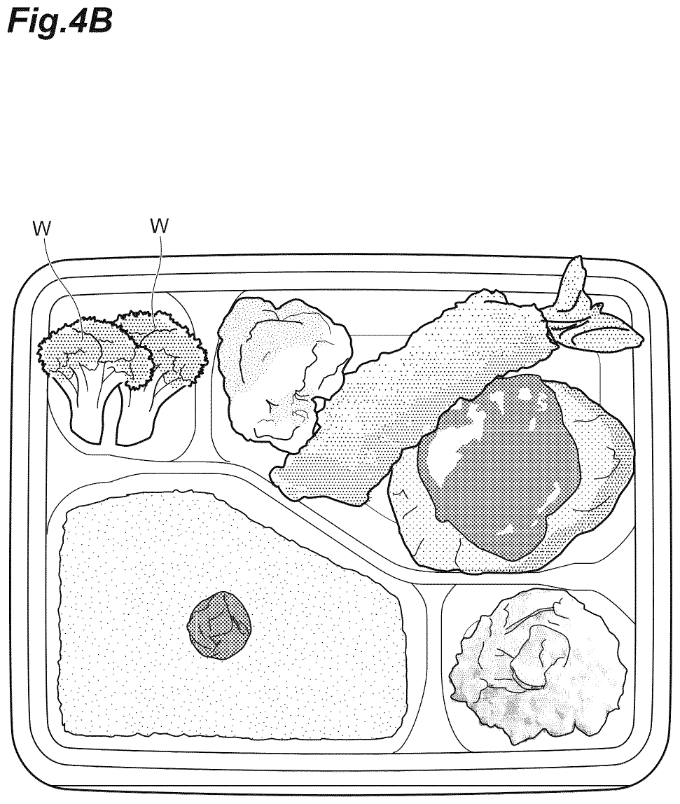

The operation of the robot system 100 will be described with reference to FIGS. 3A, 3B, 4A, and 4B, and an example of a robot control method according to the present disclosure will be described. FIG. 3A is a diagram illustrating an example operation of the robot system 100 regarding the training of the skeleton estimation model 111. FIG. 3B is a diagram illustrating an example operation of the robot system 100 regarding the control of the robot R. Therefore, the robot system 100 executes the processing illustrated in FIGS. 3A and 3B. FIGS. 4A and 4B are diagrams for explaining results of the operation of the robot system 100.

First, an example of training of the skeleton estimation model 111 will be described with reference to FIG. 3A. The training of the skeleton estimation model 111 starts from step S101. In step S101, the training data generation unit 113 acquires a 3D model and skeleton information K for a specific workpiece W corresponding to the type of workpiece to be estimated by the skeleton estimation model 111. The training data generation unit 113 acquires the 3D model of the workpiece W based on the sample images stored in the workpiece storage unit 112, and acquires the skeleton information K corresponding to the sample images. This skeleton information K includes a plurality of keys set in the 3D model. As described above, the plurality of keys include a plurality of keypoints and one or more bones each connecting two keypoints.

In step S102, the training data generation unit 113 generates a new data record of the training data. The training data generation unit 113 deforms the acquired 3D model of the workpiece W, updates the skeleton information K (plurality of keys) corresponding to the deformed 3D model, and generates a new sample image obtained from the deformed 3D model. The training data generation unit 113 associates the new sample image with the updated skeleton information K (plurality of keys) to generate a new data record. The training data generation unit 113 stores the new data record in the workpiece storage unit 112 as at least part of the training data.

In step S103, the training unit 114 checks whether a sufficient amount of training data required for training the skeleton estimation model 111 has been prepared. If the training data is not sufficient, the process returns to step S102, and the training data generation unit 113 further generates a new data record. If a sufficient amount of training data has been prepared, the process proceeds to step S104.

In step S104, the training unit 114 generates the skeleton estimation model 111 by machine learning using the training data.

In step S105, the training unit 114 stores the generated skeleton estimation model 111 in the skeleton estimation unit 110.

According to this training, training data may be prepared by deforming the 3D model of the workpiece W, and the skeleton estimation model 111 may be trained using the training data. Since a sufficient amount of training data required for training may be prepared without manually creating a large number of 3D models, the construction cost of the robot system 100 may be reduced.

Next, an example of control of the robot R will be described with reference to FIG. 3B. The control of the robot R starts from step S201. In step S201, the camera C acquires a workpiece image showing the workpiece W. For example, the camera C captures a workpiece image as illustrated in FIG. 2B.

In step S202, the skeleton estimation unit 110 acquires the workpiece image and estimates the skeleton information K of the workpiece W included in the workpiece image. In the example of FIG. 2B, the skeleton estimation unit 110 estimates the skeleton information K for each of the plurality of workpieces (broccoli) W in the workpiece image.

In step S203, the workpiece selection unit 120 selects a workpiece W to be processed in the next task, based on the skeleton information K of each of the one or more workpieces W.

In step S204, the start state determination unit 130 determines a picking position A as the start state. In the example of FIG. 2B, the broccoli in the upper center is selected, and the start state determination unit 130 determines the picking position A of the selected broccoli.

In step S205, the completion state determination unit 140 determines the completion state of the task to be performed on the selected workpiece W. FIGS. 4A and 4B illustrate examples of the completion state of the task. In these examples, it is assumed that the task is pick-and-place of a workpiece (broccoli) W. FIG. 4A illustrates a state where each broccoli is placed so that the orientation of the broccoli is not uniform, and FIG. 4B illustrates a state where each broccoli is placed so that the orientation of the broccoli is uniform. For example, it is assumed that placing the broccoli with their orientations aligned is set as at least part of the constraint. In this case, the completion state determination unit 140 determines, as the completion state when placing the left broccoli illustrated in FIG. 4B, a state where the orientations of the left and right broccoli are aligned. That is, the completion state determination unit 140 determines the position and posture of the left broccoli after placement such that the orientations of the left and right broccoli are aligned.

In step S206, the end state determination unit 142 determines the end state of the robot R in the determined completion state.

In step S207, the path generation unit 150 generates a path connecting the start state and the end state. As a result, it is determined that the robot R picks the workpiece W in the start state and places the workpiece W in the end state, and a path connecting the start state and the end state is prepared.

In step S208, the path generation unit 150 checks whether the path has been able to be generated. If the path has not been generated, the process returns to step S204. In this case, at least one of re-determination of the end state by the end state determination unit 142 and re-determination of the start state by the start state determination unit 130 is executed. That is, the robot system 100 re-determines at least one of the end state and the start state in a case where the path has not been generated. The path generation unit 150 generates (regenerates) a path based on at least one of the re-determined end state and the re-determined start state. If the path has been generated, the process proceeds to step S209.

In step S209, the robot control unit 160 causes the robot R to perform the task in accordance with the determined completion state. In a case where the task is pick-and-place, the robot R picks the workpiece W in the determined start state, conveys the workpiece W along the generated path, and places the workpiece W in the determined end state. In the example of FIG. 4B, even for an irregularly shaped workpiece W such as broccoli, the robot system 100 picks and places each workpiece W such that the orientations of the plurality of workpieces W are aligned. With such a mechanism, the quality of the task may be improved and the types of workpieces that may be processed may be increased.

In step S210, the workpiece selection unit 120 checks whether there is a workpiece W to be processed in the next task (that is, whether to repeat the task). If such a workpiece W exists, the robot system 100 repeats the process from step S201 or step S203. If such a workpiece W does not exist, the robot system 100 terminates the process.

### Hardware Configuration

The series of processes described above may be executed by dedicated hardware or by software. In a case where the series of processes is executed by software, the series of processes described above may be realized by causing a general-purpose or dedicated computer to execute a program. The computer may have a central processing unit (CPU), a recording device such as a hard disk drive(HDD), read only memory (ROM), and random access memory (RAM), a communication device connected to a network such as a local area network (LAN) and the Internet, an input device such as a mouse and a keyboard, a drive for reading and writing a removable storage medium such as a magnetic disk like a flexible disk, various compact discs (CDs), magneto optical (MO) disks, digital versatile discs (DVDs), and a semiconductor memory, a display device such as a monitor, and an output device such as a sound output device like a speaker or headphones. This computer may execute the series of processes described above by executing a program recorded on the recording device or a removable storage medium, or a program acquired via a network.

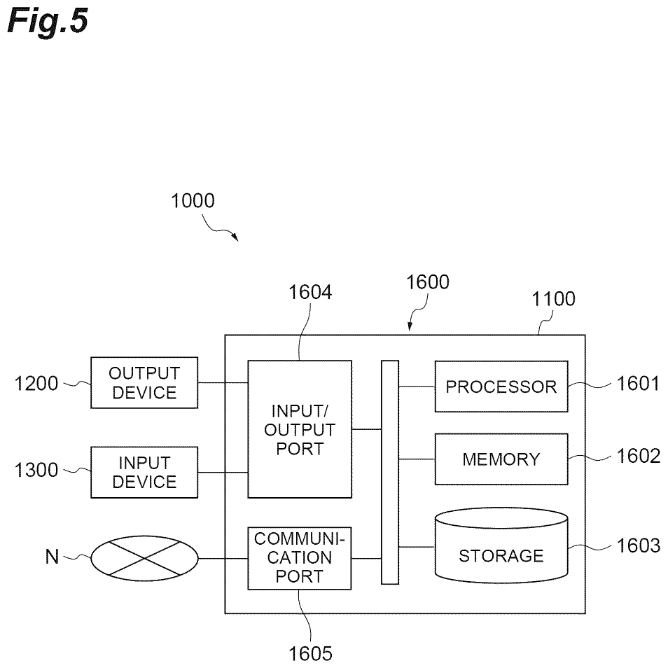

FIG. 5 is a diagram illustrating an example hardware configuration of a computer 1000 used for the robot system according to the present disclosure. In this example, the computer 1000 includes a main body 1100, an output device 1200, and an input device 1300.

The main body 1100 is a device having circuitry 1600. The circuitry 1600 has a processor 1601, a memory 1602, a storage 1603, an input/output port 1604, and a communication port 1605. The number of each hardware component may be one or two or more. The storage 1603 records a program for configuring each functional module of the main body 1100. The storage 1603 is a computer-readable recording medium such as a hard disk, a non-volatile semiconductor memory, a magnetic disk, or an optical disc. The memory 1602 temporarily stores a program loaded from the storage 1603, a calculation result of the processor 1601, and the like. The processor 1601 configures each functional module by executing the program in cooperation with the memory 1602. The input/output port 1604 inputs and outputs electrical signals to and from the output device 1200 or the input device 1300 in response to a command from the processor 1601. The input/output port 1604 may input and output electrical signals to and from other devices. The communication port 1605 performs data communication with other devices via a communication network N in accordance with a command from the processor 1601.

The output device 1200 is a device for outputting information from the main body 1100. Examples of the output device 1200 include a display device such as various displays, and a speaker.

The input device 1300 is a device for inputting information to the main body 1100. Examples of the input device 1300 include an operation interface such as a keypad, a mouse, and an operation controller.

The output device 1200 and the input device 1300 may be integrated as a touch panel. For example, the main body 1100, the output device 1200, and the input device 1300 may be integrated like a tablet computer.

Each functional module of the robot system is realized by loading a robot control program onto the processor 1601 or the memory 1602 and causing the processor 1601 to execute the program. The robot control program includes code for realizing each functional module of the robot system. The processor 1601 operates the input/output port 1604 and the communication port 1605 according to the robot control program, and executes reading and writing of data in the memory 1602 or the storage 1603.

The robot control program may be provided after being recorded on a non-transitory recording medium such as a CD-ROM, a DVD-ROM, or a semiconductor memory. Alternatively, the robot control program may be provided as a data signal superimposed on a carrier wave via a communication network.

It is to be understood that not all aspects, advantages and features described herein may necessarily be achieved by, or included in, any one particular example. Indeed, having described and illustrated various examples herein, it should be apparent that other examples may be modified in arrangement and detail.

### Additional Examples

### (Picking Position Estimation Model)

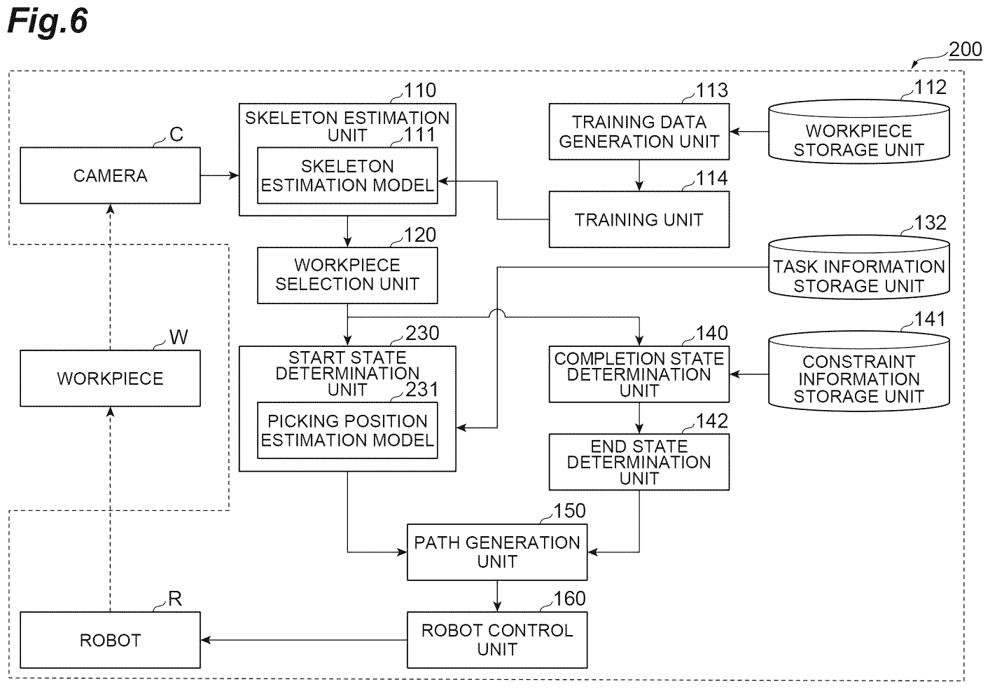

In the above examples, the start state determination unit 130 determines the picking position A as the start state based on the skeleton information K, but the start state determination unit may determine the picking position A directly from the workpiece image. This modification will be described with reference to FIG. 6.

FIG. 6 is a diagram illustrating a configuration of a robot system 200 according to a modification. The robot system 200 differs from the robot system 100 in that it includes a start state determination unit 230 instead of the start state determination unit 130. Description of the same configuration as the robot system 100 is omitted.

The start state determination unit 230 has a picking position estimation model 231. In some examples, the memory 1602 or the storage 1603 stores the picking position estimation model 231. The picking position estimation model 231 is generated in advance by machine learning using training data including a plurality of data records. Each data record indicates a correspondence between a sample image based on a 3D model of the workpiece W and picking information indicating whether the robot R is able to pick the 3D model at a position corresponding to a key set in the 3D model. The picking information is associated with at least one key among a plurality of keys set in the 3D model. The plurality of keys include a plurality of keypoints P and one or more bones S each connecting two keypoints P. In a training phase, the picking position estimation model 231 is trained with picking information associated with keys as training data. However, in an inference phase (operation phase), when receiving an input of a workpiece image showing the workpiece W, the picking position estimation model 231 processes the workpiece image without using keys and outputs a picking position A. Therefore, the start state determination unit 230 inputs the workpiece image into the picking position estimation model 231 to determine the picking position A for the robot R on the workpiece W. The picking position estimation model 231 may be realized, for example, by a neural network model such as a CNN. In some examples, the robot control unit 160 causes the robot R to perform a task on the workpiece W based on the end state and the picking position.

### (Processing Based on Score)

As described above, the workpiece processed by the robot may be a flexible object in which individual differences in shape may be ignored but the difference in the degree of deformation between individuals may be large. In this case, the skeleton estimation unit 110 may estimate a plurality of keypoints of the workpiece, calculate a score for the plurality of keypoints, and estimate a posture (e.g., orientation) of the workpiece as at least part of the skeleton information based on this score.

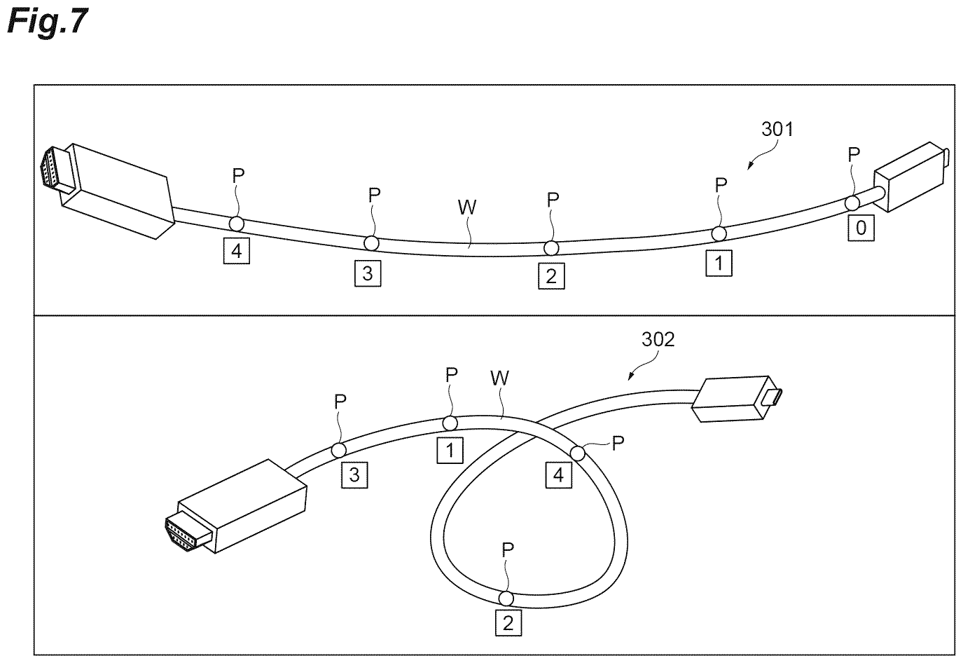

The estimation of the posture of the workpiece based on the score will be described with reference to FIG. 7. FIG. 7 is a diagram illustrating an example of keypoints P of the workpiece W estimated using the skeleton estimation model 111. In this example, the skeleton estimation unit 110 estimates the orientation of the workpiece W as at least part of the skeleton information. This estimation is also referred to as head-tail determination. The workpiece W is a conversion cable for transmitting signals between input/output terminals with different standards. It is assumed that the skeleton estimation model 111 has been trained to estimate a maximum of five keypoints P for the workpiece W. In the estimation of the keypoints P, the skeleton estimation model 111 sets an identifier for each keypoint P to distinguish individual keypoints P. In a situation 301, the skeleton estimation model 111 has estimated five keypoints P with identifiers 0 to 4 sequentially from the head-side input/output terminal (the right-side terminal in FIG. 7) toward the tail-side input/output terminal (the left-side terminal in FIG. 7), which is an ideal estimation. In contrast, in a situation 302, the skeleton estimation model 111 has estimated only four keypoints P, and the identifiers are not arranged in order along the extending direction of the workpiece W. The skeleton estimation unit 110 executes processing for accurately performing head-tail determination even in a case where the skeleton estimation model 111 does not accurately estimate the keypoints P as in the situation 302.

In some examples, the skeleton estimation unit 110 defines in advance a weight corresponding to the identifier for each of a plurality of keypoints P that may be detected. In addition, the skeleton estimation unit 110 sets a status for each individual keypoint P indicating whether the keypoint has been detected. The status is 1 if the keypoint has been detected, and 0 if the keypoint has not been detected. The skeleton estimation unit 110 divides the workpiece W into two regions based on the midpoint of a line segment connecting a first end and a second end of the workpiece W, and determines in which of the two divided regions each detected keypoint P is located. The skeleton estimation unit 110 calculates, for each of the plurality of keypoints P that may be detected, a product of the weight, the status, and a predetermined area value assigned to the divided region where the keypoint P is located. Then, the skeleton estimation unit 110 calculates a score based on the sum of a plurality of products corresponding to the plurality of keypoints P. The skeleton estimation unit 110 determines that the first end is the head-side input/output terminal if the score satisfies a predetermined condition, and determines that the second end is the head-side input/output terminal if the score does not satisfy the predetermined condition.

That is, the skeleton estimation unit 110 estimates the identifier and position of each of the plurality of keypoints P of the workpiece W. Then, the skeleton estimation unit 110 calculates a score based on the identifier and position of each of the plurality of keypoints P, and estimates the posture of the workpiece W as at least part of the skeleton information based on the score.

The workpiece selection unit 120 may use the score to select at least one workpiece from a plurality of workpieces included in the workpiece image. In this case, the skeleton estimation unit 110 calculates a score for each of the plurality of workpieces. The workpiece selection unit 120 selects at least one workpiece as a workpiece to be processed in the task, based on the score of each of the plurality of workpieces. For example, the workpiece selection unit 120 may select a workpiece whose score is equal to or greater than a predetermined threshold, or may select a workpiece with the highest score.

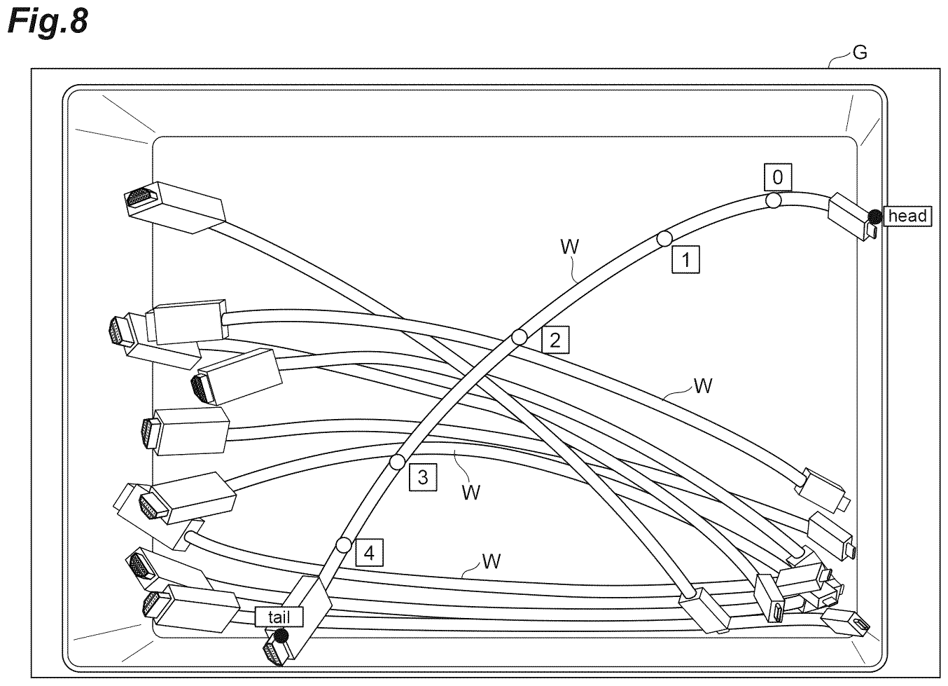

FIG. 8 is a diagram illustrating an example process of selecting a workpiece. In this example, a workpiece image G includes a plurality of workpieces (conversion cables) W stored in a box. The skeleton estimation unit 110 calculates a score for each of the plurality of workpieces W and performs the head-tail determination for each workpiece W. In the example of FIG. 8, the workpiece selection unit 120 selects the workpiece W located at the top in the box, that is, the workpiece W located closest to the camera C, based on the scores of the plurality of workpieces W. In the example of FIG. 8, the result of the head-tail determination for the selected workpiece W is indicated by labels “head”and “tail”, respectively.

### (Check of Processed Workpiece)

The robot systems 100, 200 may check the processed workpiece. In this example, the camera C captures and acquires a new workpiece image showing the workpiece processed in the task performed by the robot R. The skeleton estimation unit 110 estimates new skeleton information indicating the skeleton of the workpiece based on the new workpiece image. The completion state determination unit 140 determines whether the processed workpiece satisfies the constraint based on the new skeleton information. If the processed workpiece satisfies the constraint, the robot system 100, 200 determines whether to cause the robot R to perform a task on another workpiece. This process corresponds to the above-mentioned step S210. If the processed workpiece does not satisfy the constraint, the robot control unit 160 may cause the robot R to perform the task again in accordance with the new skeleton information such that the workpiece satisfies the constraint. Alternatively, the completion state determination unit 140 may notify the user of the robot system 100, 200 with a message indicating that the constraint is not satisfied.

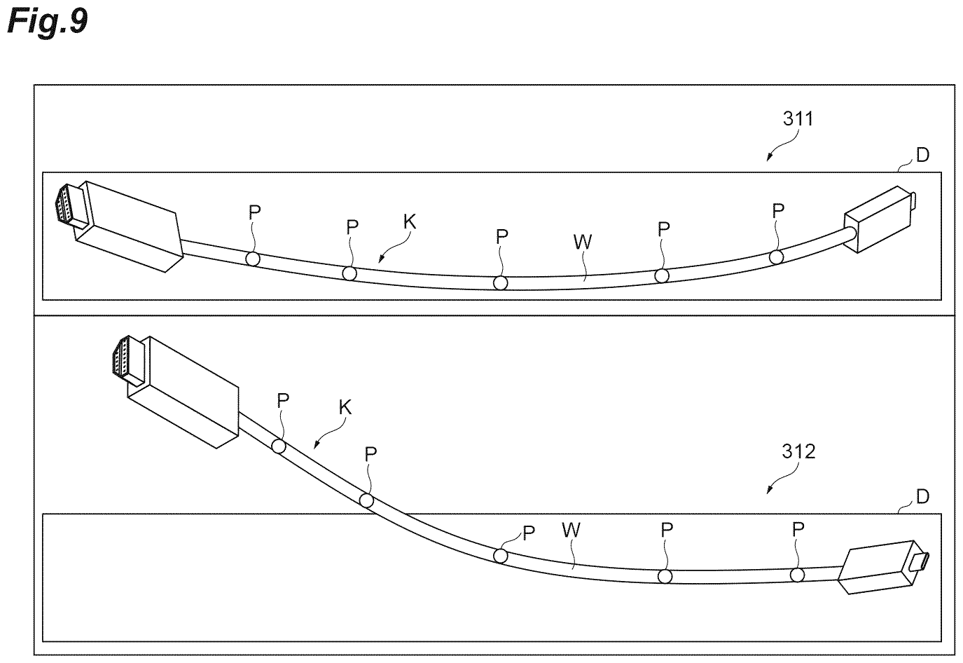

FIG. 9 is a diagram illustrating examples of processed workpieces. In this example, the constraint includes a condition of placing the workpiece (conversion cable) W within a placement region D. In both situations 311 and 312, the skeleton estimation unit 110 estimates new skeleton information K including a plurality of keypoints P of the processed workpiece W. The completion state determination unit 140 determines whether the workpiece W satisfies the constraint based on the skeleton information K. For example, the completion state determination unit 140 determines that the constraint is satisfied if the ratio of the workpiece W that is within the placement region D is equal to or greater than a predetermined threshold, and determines that the constraint is not satisfied if the ratio is less than the threshold. The completion state determination unit 140 may determine that the constraint is satisfied if the number of keypoints P that are within the placement region D is equal to or greater than a predetermined threshold, and determine that the constraint is not satisfied if the number is less than the threshold. In the situation 311, the completion state determination unit 140 determines that the workpiece W satisfies the constraint. In the situation 312, the completion state determination unit 140 determines that the workpiece W does not satisfy the constraint. As described above, in the situation 312, the robot control unit 160 may cause the robot R to perform the task of placing the workpiece W within the placement region D again in accordance with the new skeleton information K.

### (Generation of Constraint Information)

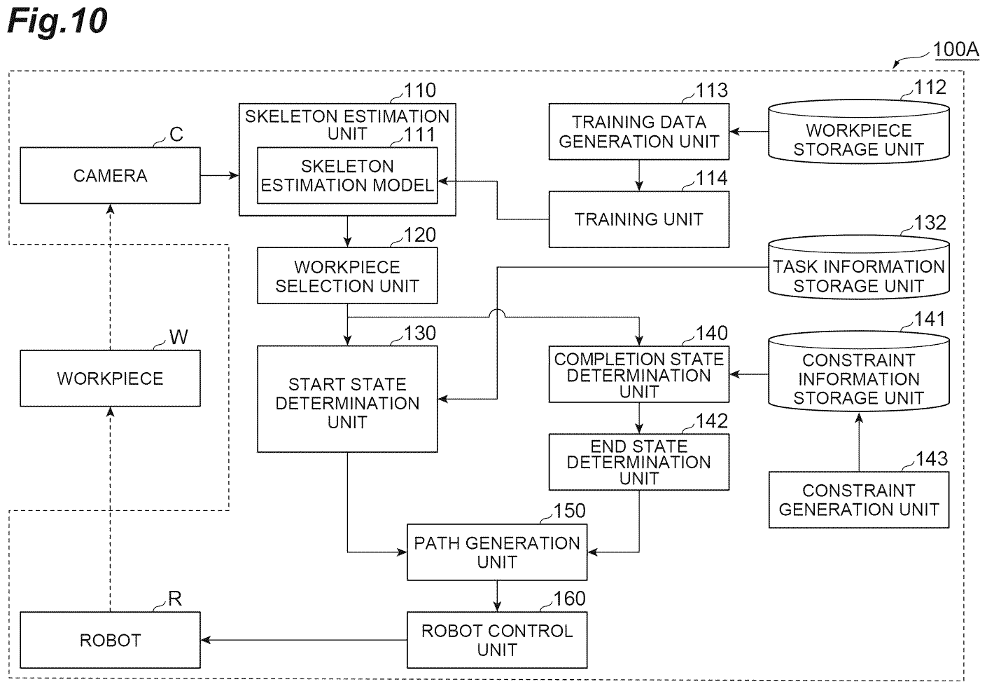

The robot system may include a functional module that generates the constraint information. This modification will be described with reference to FIG. 10. FIG. 10 is a diagram illustrating a configuration of a robot system 100A according to a modification. The robot system 100A differs from the robot system 100 in that it further includes a constraint generation unit 143. Description of the same configuration as the robot system 100 is omitted.

The constraint generation unit 143 is a functional module that generates the constraint information based on a teaching image indicating a goal of a state of the workpiece when the task is completed. The teaching image prepared in advance may be generated by capturing an image of a real workpiece, or may be generated by drawing a virtual workpiece with computer graphics. The constraint generation unit 143 estimates teaching skeleton information indicating a skeleton of the workpiece in the teaching image, and generates the constraint information based on this teaching skeleton information. Similar to the skeleton information K described above, the teaching skeleton information also includes a plurality of keys including a plurality of keypoints and one or more bones each connecting two keypoints. Similar to the skeleton estimation unit 110, the constraint generation unit 143 may estimate the teaching skeleton information from the teaching image using the skeleton estimation model 111. The constraint generation unit 143 may set the posture (e.g., orientation) of the workpiece indicated by the teaching skeleton information as a constraint, and generate the constraint information indicating that constraint. Alternatively, the constraint generation unit 143 may display a user interface for generating the constraint information, and generate the constraint information based on the estimated teaching skeleton information and user input received via the user interface. As described above, the constraint information is generated for each type of workpiece.

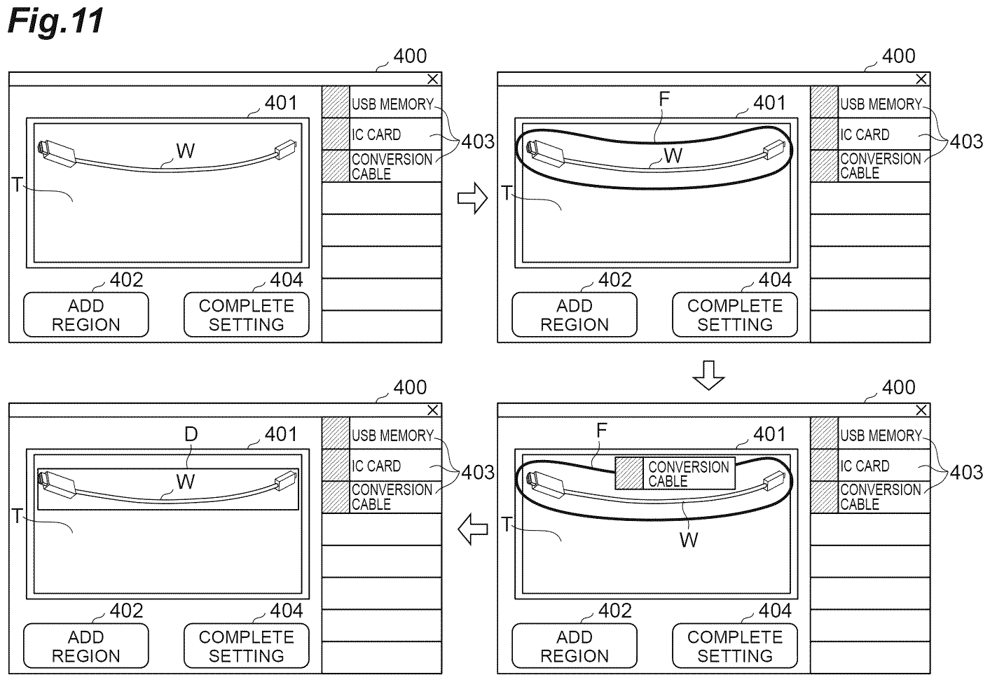

FIG. 11 is a diagram illustrating an example user interface for generating constraint information for a pick-and-place task. The user interface 400 illustrated in this example includes an image display area 401 that displays a teaching image T designated by a user, a region addition button 402 which is a button for defining a placement region D that is a region where the workpiece W is to be placed by the pick-and-place task, a label 403 for designating the type of workpiece, and a setting completion button 404 for confirming the constraint information.

In some examples, the user first causes an expected teaching image T to be displayed in the image display area 401. The teaching image T is an image showing an ideal state of the workpiece (conversion cable) W to be placed by the pick-and-place task, that is, a state of the workpiece W after placement that the user expects from the robot R. Subsequently, the user clicks or taps the region addition button 402 and designates a region where the workpiece W should be placed by drawing a frame F with a pointing device. Subsequently, the user moves the label 403 corresponding to the workpiece W in the teaching image T to the workpiece W on the teaching image T by a drag operation to set the conversion cable as the type of the workpiece W. In response to this setting, the constraint generation unit 143 estimates the teaching skeleton information indicating at least the posture of the workpiece W represented by the skeleton of the workpiece W. Then, the constraint generation unit 143 generates the constraint information representing a placement region D as at least part of the constraint for the conversion cable, based on the estimated posture and the designated frame F. The constraint generation unit 143 stores the generated constraint information in the constraint information storage unit 141 in response to the user clicking or tapping the setting completion button 404. The constraint information may be referred to by the completion state determination unit 140 to determine the completion state of the pick-and-place task performed on each workpiece (conversion cable) W.

As a modification of the constraint generation unit 143 and the user interface 400, the constraint generation unit 143 may generate the constraint information indicating the placement region D based on the posture of the workpiece indicated by the teaching skeleton information, without receiving an input of the frame F from the user. As another example, the constraint generation unit 143 may display a dialog screen for adjusting the automatically set placement region D in response to a predetermined user operation on the user interface 400, and change the position, shape, orientation, etc. of the placement region D based on user input on the dialog screen.

The various examples of the present disclosure have been described in detail above with reference to the accompanying drawings. However, it goes without saying that the scope of the technical idea of the present disclosure is not limited to the examples described above. It is clear that a person having ordinary skill in the technical field related to the present disclosure can conceive of various changes, modifications, combinations, and the like within the scope of the technical idea of the present disclosure described in the claims. Therefore, techniques to which these changes, modifications, and combinations are applied also naturally belong to the scope of the technical idea of the present disclosure.

In the present specification, the processing flow described in the flowchart includes not only processing performed chronologically in the described order, but also processing executed in parallel or individually instead of chronologically. Furthermore, it goes without saying that even in a case where the processing is performed chronologically, the order of the steps may be changed.

The hardware configuration of the system is not limited to an aspect in which each functional module is realized by executing a program. For example, at least a part of the functional module group described above may be configured by a logic circuit specialized for the function, or may be configured by an application specific integrated circuit (ASIC) in which the logic circuit is integrated.

In a case where comparing the magnitude relationship between two numerical values in a computer system or a computer, either of the two criteria “equal to or greater than” and “greater than” may be used, and either of the two criteria “equal to or less than” and “less than” may be used.

### APPENDIX

As understood from the various examples described above, the present disclosure includes the following aspects.

### (Aspect 1)

A robot system comprising:
a skeleton estimation unit configured to estimate skeleton information indicating a skeleton of a workpiece based on a workpiece image showing the workpiece present in real space;
a completion state determination unit configured to determine a completion state of a task to be performed on the workpiece, based on constraint information representing a constraint regarding the task on the workpiece and the estimated skeleton information; and
a robot control unit configured to cause a robot placed in the real space to perform the task in accordance with the determined completion state.
   In this case, the completion state of the task to be performed on the workpiece is determined based on the skeleton of the workpiece, and the robot is controlled based on the completion state. Such processing may make it possible to cause the robot to perform detailed tasks according to the shape of the workpiece actually being processed or changes in the shape. Therefore, the reliability of tasks for workpieces may be improved. For example, the accuracy of tasks for workpieces may be increased. In some examples, the types of workpieces processed by the robot may be also increased, that is, the scope of provision of the robot system may be expanded.

### (Aspect 2)

The robot system according to aspect 1,
wherein the task includes a pick-and-place task performed by the robot on the workpiece, and
wherein the completion state determination unit is configured to determine, as the completion state, at least a post-placement state, which is a state after the workpiece is placed.
   In this case, since the state of the workpiece placed by the robot is determined as the completion state, the pick-and-place task may be controlled with higher accuracy.

### (Aspect 3)

The robot system according to aspect 2,
wherein the workpiece is an irregularly shaped workpiece,
wherein the task includes a pick-and-place task performed by the robot on the irregularly shaped workpiece, and
wherein the completion state determination unit is configured to determine, as the post-placement state, at least a posture of the placed workpiece.
   In this case, since the posture of the irregularly shaped workpiece that has been placed is determined as the post-placement state (completion state), the pick-and-place task for the irregularly shaped workpiece may be controlled with higher accuracy.

### (Aspect 4)

The robot system according to any one of aspects 1 to 3, further comprising an end state determination unit configured to determine, based on the determined completion state, an end state, which is a state of the robot in the completion state,
wherein the robot control unit is configured to cause the robot to perform the task based on the determined end state.
   In this case, since the end state, which is the state of the robot when the task is completed, is determined based on the completion state, and the robot is controlled based on the end state, the robot may be operated more accurately in response to the shape of the workpiece more flexibly.

### (Aspect 5)

The robot system according to aspect 4, further comprising a start state determination unit configured to determine, based on the skeleton information, a start state, which is a state of the robot at a start of the task,
wherein the robot control unit is configured to cause the robot to perform the task based on the determined start state and the end state.
   In this case, since the start state, which is the state of the robot at the start of the task, is determined based on the skeleton state, the success rate of the start of the task by the robot may be increased, and the result at the completion of the task, which is affected by the state at the start of the task, may be controlled with higher accuracy.

### (Aspect 6)

The robot system according to aspect 5, further comprising a path generation unit configured to generate a path of the robot based on the start state and the end state,
wherein the path generation unit is configured to:
   cause at least one of re-determination of the end state by the end state determination unit and re-determination of the start state by the start state determination unit to be executed in a case where the path is unable to be generated, and
   generate the path based on at least one of the re-determined end state and the re-determined start state, and
wherein the robot control unit is configured to cause the robot to perform the task based on the generated path.
   In this case, a path for the robot during the task is generated, and if the path is unable to be generated, the path is generated after the re-determination of the end state and the start state. Such automatic generation of the path may reduce the frequency of being unable to execute the task because the path is unable to be generated, and may increase the probability of completing the task while responding to various situations. For example, the probability of being able to reliably perform the task according to the surrounding environment such as obstacles or the state of the workpiece may be increased.

### (Aspect 7)

The robot system according to aspect 5 or 6,
wherein the skeleton information includes a plurality of keys including a plurality of keypoints of the workpiece and one or more bones each connecting two of the keypoints, and
wherein the start state determination unit is configured to determine the start state based on task information associated with at least one key among the plurality of keys set for each type of the workpiece and the estimated skeleton information.
   In this case, by referring to the task information corresponding to the workpiece in addition to the skeleton information of the workpiece, the robot may be made to start the task more reliably. In addition, by setting the task information, the user's intention for the task may be reflected in the robot control.

### (Aspect 8)

The robot system according to aspect 7,
wherein the task includes a pick-and-place task performed by the robot on the workpiece,
wherein the task information includes, for each of the at least one key, picking information indicating whether the robot is able to pick the workpiece at a position corresponding to the key, and
wherein the start state determination unit is configured to determine, as the start state, a picking position for the robot on the workpiece based on the picking information and the skeleton information.
   In this case, the picking position is set as the task information for each type of workpiece, and the picking position of the workpiece to be processed by the task is determined according to the task information and the skeleton information. This processing may increase the success rate of pick-and-place and control the state of the workpiece after placement.

### (Aspect 9)

The robot system according to aspect 4, further comprising a start state determination unit configured to determine a picking position for the robot on the workpiece,
wherein the task includes a pick-and-place task performed by the robot on the workpiece,
wherein the start state determination unit is configured to:
   have a picking position estimation model trained with training data including a plurality of data records indicating correspondence between sample images based on a 3D model of the workpiece and picking information indicating whether the robot is able to pick the 3D model at a position corresponding to a key set in the 3D model, wherein the picking information is associated with at least one key among a plurality of keys set in the 3D model, and wherein the plurality of keys include a plurality of keypoints and one or more bones each connecting two of the keypoints, and
   determine the picking position based on the workpiece image and the picking position estimation model, and
wherein the robot control unit is configured to cause the robot to perform the task based on the end state and the determined picking position.
   In this case, the robot may be operated by determining the picking position without determining the start state, by the picking position estimation model trained in advance with the training data indicating the correspondence between the sample images and the picking information associated with the skeleton information. In addition, by introducing the picking position estimation model, the cost of constructing the robot system may be reduced, and the accuracy of the picking position may be improved.

### (Aspect 10)

The robot system according to any one of aspects 1 to 9, further comprising a workpiece selection unit configured to select at least one workpiece from a plurality of the workpieces included in the workpiece image,
wherein the skeleton estimation unit is configured to estimate the skeleton information for each of the plurality of workpieces, and
wherein the workpiece selection unit is configured to select, based on the skeleton information of each of the plurality of workpieces, the at least one workpiece as a workpiece to be processed in the task.
   In this case, since a workpiece predicted to be appropriate as a processing target is selected based on the skeleton of each workpiece, the probability of being able to complete the task may be increased, and the quality of the task result may be improved.

### (Aspect 11)

The robot system according to aspect 10, wherein the workpiece selection unit is configured to select, based on an area and the skeleton information of each of the plurality of workpieces, a workpiece that is entirely exposed in the workpiece image as a workpiece to be processed in the task.

In this case, since a workpiece that is entirely exposed in the workpiece image, that is, a workpiece that is expected to be easy to process, is selected, the probability of being able to complete the task may be further increased.

### (Aspect 12)

The robot system according to aspect 10, wherein the workpiece selection unit is configured to select, based on the skeleton information of each of the plurality of workpieces, a workpiece having a degree of deformation within a predetermined range as a workpiece to be processed in the task.

In this case, since a workpiece that is relatively close to the typical posture of the workpiece, that is, a workpiece that is expected to be easy to process, is selected, the quality of the task result may be further improved.

### (Aspect 13)

The robot system according to any one of aspects 1 to 12, wherein the skeleton estimation unit is configured to:
calculate a score for a plurality of keypoints of the workpiece, and
estimate a posture of the workpiece as at least part of the skeleton information based on the score.
   In this case, since the posture of the workpiece is estimated by the score calculated for the plurality of keypoints of the workpiece, the posture of the workpiece may be estimated more accurately. As a result, the accuracy of the task on the workpiece may be further increased.

### (Aspect 14)

The robot system according to any one of aspects 1 to 13, wherein the skeleton estimation unit is configured to estimate, based on a new workpiece image showing the workpiece processed in the task performed by the robot, new skeleton information indicating a skeleton of the processed workpiece, and
wherein the completion state determination unit is configured to determine whether the processed workpiece satisfies the constraint, based on the estimated new skeleton information.
   In this case, whether the processed workpiece satisfies the constraint is determined based on the skeleton of the workpiece. This mechanism allows for automatic monitoring of whether the robot has properly processed the workpiece.

### (Aspect 15)

The robot system according to aspect 14, wherein the robot control unit is configured to cause, in a case where the processed workpiece does not satisfy the constraint, the robot to perform the task again in accordance with the estimated new skeleton information.

In this case, if the processed workpiece does not satisfy the constraint, the robot re-processes the workpiece based on the current skeleton of the workpiece. Such processing may further improve the quality of the task result.

### (Aspect 16)

The robot system according to any one of aspects 1 to 15, further comprising a constraint generation unit configured to estimate, based on a teaching image indicating a goal of a state of the workpiece in a case where the task is completed, teaching skeleton information indicating a skeleton of the workpiece in the teaching image, and generate the constraint information based on the teaching skeleton information.

In this case, since the constraint information is generated based on the workpiece indicated by the teaching image, the constraint for the task on the workpiece may be readily set.

### (Aspect 17)

The robot system according to aspect 16, wherein the task includes a pick-and-place task performed by the robot on the workpiece, and
wherein the constraint generation unit is configured to:
   estimate a posture of the workpiece in the teaching image as at least part of the teaching skeleton information, and
   generate the constraint information representing, as at least part of the constraint, a placement region that is a region where the workpiece is to be placed by the pick-and-place task, based on the estimated posture.
      In this case, since the placement region of the workpiece is set based on the posture of the workpiece in the teaching image, an appropriate placement region suitable for the type of workpiece may be readily set.

### (Aspect 18)

A robot control method executed by a robot system comprising at least one processor, the method comprising:
estimating skeleton information indicating a skeleton of a workpiece based on a workpiece image showing the workpiece present in real space;
determining a completion state of a task to be performed on the workpiece, based on constraint information representing a constraint regarding the task on the workpiece and the estimated skeleton information; and
causing a robot placed in the real space to perform the task in accordance with the determined completion state.
   In this case, the completion state of the task to be performed on the workpiece is determined based on the skeleton of the workpiece, and the robot is controlled based on the completion state. Such processing may make it possible to cause the robot to perform detailed tasks according to the shape of the workpiece actually being processed or changes in the shape. Therefore, the reliability of tasks for workpieces may be improved. For example, the accuracy of tasks for workpieces may be increased. In some examples, the types of workpieces processed by the robot may be also increased, that is, the scope of provision of the robot system may be expanded.

### (Aspect 19)

A robot control program for causing a computer to execute:
estimating skeleton information indicating a skeleton of a workpiece based on a workpiece image showing the workpiece present in real space;
determining a completion state of a task to be performed on the workpiece, based on constraint information representing a constraint regarding the task on the workpiece and the estimated skeleton information; and
causing a robot placed in the real space to perform the task in accordance with the determined completion state.
   In this case, the completion state of the task to be performed on the workpiece is determined based on the skeleton of the workpiece, and the robot is controlled based on the completion state. Such processing may make it possible to cause the robot to perform detailed tasks according to the shape of the workpiece actually being processed or changes in the shape. Therefore, the reliability of tasks for workpieces may be improved. For example, the accuracy of tasks for workpieces may be increased. In some examples, the types of workpieces processed by the robot may be also increased, that is, the scope of provision of the robot system may be expanded.

### (Aspect 20)

The robot system according to any one of aspects 1 to 17,
wherein the skeleton estimation unit is configured to estimate the skeleton information based on the workpiece image, using a skeleton estimation model trained with training data including a plurality of data records each including a sample image based on a 3D model of the workpiece and a plurality of keys set in the 3D model, wherein the plurality of keys include a plurality of keypoints and one or more bones each connecting two of the keypoints.
   In this case, the skeleton information is estimated by the skeleton estimation model trained in advance with the training data indicating the correspondence between the sample images and the plurality of keys corresponding to the workpiece. By introducing the skeleton estimation model, the cost of constructing the robot system may be reduced, and the accuracy of estimating the skeleton of the workpiece may be improved.

### (Aspect 21)

The robot system according to aspect 20, further comprising:
a training data generation unit configured to deform the 3D model indicated by one data record of the plurality of data records to generate a new data record of the training data; and
a training unit configured to train the skeleton estimation model using at least the new data record.

In this case, since the amount of training data for training the skeleton estimation model is automatically increased by deforming the existing 3D model, the cost of performing the training may be reduced.

### (Aspect 22)

The robot system according to aspect 13, further comprising a workpiece selection unit configured to select at least one workpiece from a plurality of the workpieces included in the workpiece image,
wherein the skeleton estimation unit is configured to calculate the score for each of the plurality of workpieces, and
wherein the workpiece selection unit is configured to select the at least one workpiece as the workpiece to be processed in the task, based on the score of each of the plurality of workpieces.
   In this case, since a workpiece predicted to be appropriate as a processing target is selected based on the score of each workpiece, the probability of being able to complete the task may be increased, and the quality of the task result may be improved.

1. A robot system comprising circuitry configured to:
acquire a workpiece image showing a workpiece present in real space;
estimate skeleton information indicating a skeleton of the workpiece based on the workpiece image;
acquire constraint information representing a constraint regarding a task to be performed on the workpiece;
determine a completion state of the task based on the acquired constraint information and the estimated skeleton information; and
cause a robot placed in the real space to perform the task in accordance with the determined completion state.

2. The robot system according to claim 1,
wherein the task includes a pick-and-place task performed by the robot on the workpiece, and
wherein the circuitry is configured to determine, as the completion state, at least a post-placement state, which is a state after the workpiece is placed.

3. The robot system according to claim 2,
wherein the workpiece is an irregularly shaped workpiece,
wherein the task includes the pick-and-place task performed by the robot on the irregularly shaped workpiece, and
wherein the circuitry is configured to determine, as the post-placement state, at least a posture of the placed workpiece.

4. The robot system according to claim 1, wherein the circuitry is configured to:
determine, based on the determined completion state, an end state, which is a state of the robot in the completion state; and
cause the robot to perform the task based on the determined end state.

5. The robot system according to claim 4, wherein the circuitry is configured to:
determine, based on the skeleton information, a start state, which is a state of the robot at a start of the task; and
cause the robot to perform the task based on the determined start state and the end state.

6. The robot system according to claim 5, wherein the circuitry is configured to:
generate a path of the robot based on the start state and the end state;
re-determine at least one of the end state and the start state in a case where the path is unable to be generated;
generate the path based on at least one of the re-determined end state and the re-determined start state; and
cause the robot to perform the task based on the generated path.

7. The robot system according to claim 5,
wherein the skeleton information includes a plurality of keys,
wherein the plurality of keys includes:
a plurality of keypoints of the workpiece; and
one or more bones each connecting two of the keypoints, and
wherein the circuitry is configured to determine the start state based on task information and the estimated skeleton information, wherein the task information is associated with at least one key among the plurality of keys set for each type of the workpiece.

8. The robot system according to claim 7,
wherein the task includes a pick-and-place task performed by the robot on the workpiece,
wherein the task information includes, for each of the at least one key, picking information indicating whether the robot is able to pick the workpiece at a position corresponding to the key, and
wherein the circuitry is configured to determine, as the start state, a picking position for the robot on the workpiece based on the picking information and the skeleton information.

9. The robot system according to claim 4, further comprising a memory storing a picking position estimation model trained with training data including a plurality of data records indicating correspondence between sample images based on a 3D model of the workpiece and picking information indicating whether the robot is able to pick the 3D model at a position corresponding to a key set in the 3D model, wherein the picking information is associated with at least one key among a plurality of keys set in the 3D model, and wherein the plurality of keys include a plurality of keypoints and one or more bones each connecting two of the keypoints,
wherein the task includes a pick-and-place task performed by the robot on the workpiece, and
wherein the circuitry is configured to:
determine a picking position for the robot on the workpiece based on the workpiece image and the picking position estimation model; and
cause the robot to perform the task based on the end state and the determined picking position.

10. The robot system according to claim 1, wherein the circuitry is configured to:
estimate the skeleton information for each of a plurality of the workpieces; and
select, based on the skeleton information of each of the plurality of workpieces, at least one workpiece from a plurality of the workpieces included in the workpiece image, as a workpiece to be processed in the task.

11. The robot system according to claim 10, wherein the circuitry is configured to select, based on an area and the skeleton information of each of the plurality of workpieces, a workpiece that is entirely exposed in the workpiece image as the workpiece to be processed in the task.

12. The robot system according to claim 10, wherein the circuitry is configured to select, based on the skeleton information of each of the plurality of workpieces, a workpiece having a degree of deformation within a predetermined range as the workpiece to be processed in the task.

13. The robot system according to claim 1, wherein the circuitry is configured to:
calculate a score for a plurality of keypoints of the workpiece; and
estimate a posture of the workpiece as at least part of the skeleton information based on the score.

14. The robot system according to claim 1, wherein the circuitry is configured to:
estimate, based on a new workpiece image showing the workpiece processed in the task performed by the robot, new skeleton information indicating a skeleton of the processed workpiece; and
determine whether the processed workpiece satisfies the constraint, based on the estimated new skeleton information.

15. The robot system according to claim 14, wherein the circuitry is configured to cause, in a case where the processed workpiece does not satisfy the constraint, the robot to perform the task again in accordance with the estimated new skeleton information.

16. The robot system according to claim 1, wherein the circuitry is configured to estimate, based on a teaching image indicating a goal of a state of the workpiece in a case where the task is completed, teaching skeleton information indicating a skeleton of the workpiece in the teaching image, and generate the constraint information based on the teaching skeleton information.

17. The robot system according to claim 16, wherein the task includes a pick-and-place task performed by the robot on the workpiece, and
wherein the circuitry is configured to:
estimate a posture of the workpiece in the teaching image as at least part of the teaching skeleton information; and
generate the constraint information representing, as at least part of the constraint, a placement region that is a region where the workpiece is to be placed by the pick-and-place task, based on the estimated posture.

18. The robot system according to claim 1, wherein the circuitry is configured to estimate the skeleton information based on the workpiece image, using a skeleton estimation model trained with training data including a plurality of data records each including a sample image based on a 3D model of the workpiece and a plurality of keys set in the 3D model, wherein the plurality of keys include a plurality of keypoints and one or more bones each connecting two of the keypoints.

19. A robot control method executable by a robot system comprising at least one processor, the method comprising:
acquiring a workpiece image showing a workpiece present in real space;
estimating skeleton information indicating a skeleton of the workpiece based on the workpiece image;
acquiring constraint information representing a constraint regarding a task to be performed on the workpiece;
determining a completion state of the task based on the acquired constraint information and the estimated skeleton information; and
causing a robot placed in the real space to perform the task in accordance with the determined completion state.

20. A non-transitory computer-readable storage medium storing processor-executable instructions to:
acquire a workpiece image showing a workpiece present in real space;
estimate skeleton information indicating a skeleton of the workpiece based on the workpiece image;
acquire constraint information representing a constraint regarding a task to be performed on the workpiece;
determine a completion state of the task based on the acquired constraint information and the estimated skeleton information; and
cause a robot placed in the real space to perform the task in accordance with the determined completion state.
